(19) United States
(12) Patent Application Publication
(10) Pub. No.: US 2019/0385264 A1
(43) Pub. Date: Dec. 19, 2019

(54) INFORMATION PROCESSING APPARATUS, INFORMATION PROCESSING METHOD AND INFORMATION PROCESSING SYSTEM

(71) Applicant: TOYOTA JIDOSHA KABUSHIKI KAISHA, Toyota-shi (JP)

(72) Inventors: Kosuke KOTAKE, Nagoya-shi (JP); Ryosuke TANIMURA, Toyota-shi (JP); Yuki ITO, Iwakura-shi (JP); Akira NISHIDA, Toyota-shi (JP); Zekai QIU, Nisshin-shi (JP); Kenichi HAGIYA, Nagoya-shi (JP); Naoki YAMAMURO, Nagoya-shi (JP)

(73) Assignee: TOYOTA JIDOSHA KABUSHIKI KAISHA, Toyota-shi (JP)

(21) Appl. No.: 16/445,783

(22) Filed: Jun. 19, 2019

(30) Foreign Application Priority Data
Jun. 19, 2018 (JP) 2018-116193

(51) Int. Cl. G06Q 50/30; G10L 25/03

(52) U.S. Cl. CPC G06Q 50/30; G10L 25/03

(57) ABSTRACT

The present disclosure provides a technique for enabling collection of useful information on a specific event. An information processing apparatus acquires conversation information relating to conversations generated in a vehicle shared among a plurality of users having a same event venue where a specific event is held as a destination. The information processing apparatus then extracts event information relating to the specific event from the acquired conversation information.

### CROSS REFERENCE TO THE RELATED APPLICATION

This application claims the benefit of Japanese Patent Application No. 2018-116193, filed on Jun. 19, 2018, which is hereby incorporated by reference herein in its entirety.

### BACKGROUND

### Technical Field

The present disclosure relates to an information processing apparatus, an information processing method and an information processing system.

### Description of the Related Art

Use of so-called ride sharing, a traveling mode in which a plurality of users share the same vehicle is becoming widespread in recent years. To use such ride sharing, techniques for matching a plurality of users are being developed.

Patent document 1 discloses a technique for determining whether or not owners of respective terminals are sharing the same vehicle.

### CITATION LIST

### Patent Document

[Patent document 1] Japanese Patent Application Laid-Open No. 2011-237842

### SUMMARY

It is an object of the present disclosure to provide a technique for allowing useful information on a specific event to be collected.

An information processing apparatus according to a first aspect of the present disclosure may be provided with a controller configured to execute: acquiring conversation information on a conversation generated in a vehicle shared among a plurality of users having a same event venue where a specific event is held as a destination; and extracting event information on the specific event from the conversation information.

An information processing method according to a second aspect of the present disclosure may include: a step of acquiring conversation information on a conversation generated in a vehicle shared among a plurality of users having a same event venue where a specific event is held as a destination; and a step of extracting event information on the specific event from the conversation information.

A non-transitory storage medium according to a third aspect of the present disclosure may be a non-transitory storage medium that stores a program for causing a computer to execute the information processing method according to the second aspect.

An information processing system according to a fourth aspect of the present disclosure may be provided with: a matching apparatus configured to match a plurality of users with a same vehicle based on destination information of each user, the plurality of users having a same event venue where a specific event is held as a destination; and an information processing apparatus configured to acquire conversation information on a conversation generated in the vehicle shared among the plurality of users and extract event information on the specific event from the conversation information.

According to the present disclosure, it is possible to collect useful information on a specific event.

### BRIEF DESCRIPTION OF THE DRAWINGS

FIG. 1 is a diagram illustrating a schematic configuration of an information processing system according to a first embodiment;

FIG. 2 is a diagram illustrating part of a hardware configuration of a matching management server or an event management server;

FIG. 3 is a block diagram schematically illustrating respective configuration examples of a user terminal, a vehicle-mounted apparatus, a matching management server and an event management server constituting the information processing system according to the first embodiment;

FIG. 4 is a diagram illustrating an example of a table configuration of user information stored in a user information DB;

FIG. 5 is a diagram illustrating an example of a table configuration of matching information stored in a matching information DB;

FIG. 6 is a flowchart illustrating a flow of extraction processing executed by an extraction unit;

FIG. 7 is a diagram illustrating an example of a table configuration of conversation information stored in the conversation information DB;

FIG. 8 is a diagram illustrating an example of a table configuration of the conversation information stored in the event information DB;

FIG. 9 is a block diagram schematically illustrating respective configuration examples of a user terminal, a vehicle-mounted apparatus, a matching management server and an event management server constituting an information processing system according to a modification of the first embodiment;

FIG. 10 is a block diagram schematically illustrating respective configuration examples of a user terminal, a vehicle-mounted apparatus, a matching management server and an event management server constituting the information processing system according to a second embodiment; and

FIG. 11 is a diagram illustrating processing executed by the event management server and the vehicle-mounted apparatus and a flow of transmission/reception of information between both apparatuses, according to the second embodiment.

### DESCRIPTION OF THE EMBODIMENTS

An information processing apparatus according to a first aspect of the present disclosure may be provided with a controller that acquires conversation information on a conversation generated by a plurality of users in a vehicle shared among the plurality of users. In this aspect, the “plurality of users” sharing a vehicle may be users having the same event venue where a specific event is held as a destination. It is possible to match the plurality of users having the same event venue as the destination with the same vehicle by, for example, acquiring destination information, which is information on the destination of each user. Performing such matching allows the plurality of users heading for the same event venue to get in the same vehicle. Note that the “event” according to the present disclosure may be any event as long as it is an event in which an unspecified large number of people participate (also including a case where people participate as spectators). Examples of the “event” according to the present disclosure include entertainment, movie presentation, lecture, exhibition, match, rite and festival, and so on.

As described above, when a plurality of users having an event venue where a specific event is held as a destination are sharing the same vehicle, it is assumed that the plurality of users are likely to engage in conversation relating to the specific event in the vehicle (that is, the vehicle traveling toward the event venue). Therefore, the conversation information acquired by the controller is likely to include many pieces of information on the specific event. Thus, the controller in the information processing apparatus according to the present aspect may extract event information which is information on the specific event from the acquired conversation information.

In this way, the information processing apparatus can acquire event information based on conversations held among the plurality of users heading for the same event venue by sharing the same vehicle. It is thereby possible to collect event information from conversations held among the plurality of users who are highly interested in the specific event and performed in the same time period as the specific event. Therefore, it is possible to collect useful information on the specific event.

Hereinafter, specific embodiments of the present disclosure will be described based on the accompanying drawings. Sizes, materials, shapes and relative arrangements or the like of components described in the present embodiments are not intended to limit the technical scope of the disclosure unless specified otherwise.

### FIRST EMBODIMENT

### Overview of System

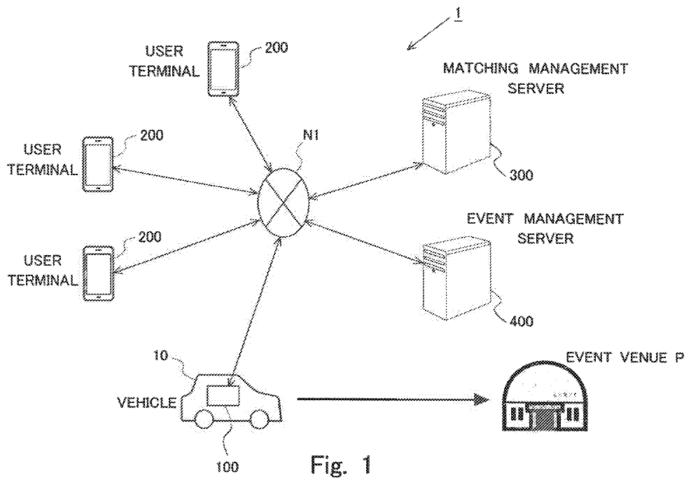

FIG. 1 is a diagram illustrating a schematic configuration of an information processing system according to a first embodiment. An information processing system 1 is constructed of a user terminal 200 owned by each user, a vehicle-mounted apparatus 100 mounted on a vehicle 10, a matching management server 300 and an event management server 400. Note that each user of the information processing system 1 in the present embodiment is a person who participates in a desired event. There are as many user terminals 200 as users using the information processing system 1. The vehicle 10 is a vehicle shared among a plurality of users heading for an identical event venue P.

In the information processing system 1, each user terminal 200, the vehicle-mounted apparatus 100, the matching management server 300 and the event management server 400 are mutually connected via a network N1. For example, a WAN (Wide Area Network) which is a world-wide scale public communication network such as the Internet and other communication networks may be adopted as the network N1. Furthermore, the network N1 may include a telephone communication network such as a mobile phone and a wireless communication network such as Wi-Fi.

A predetermined application for using a matching service in the information processing system 1 is installed in each user terminal 200. Here, the matching service is a service for providing to a user, a vehicle to be shared with other users as traveling means heading for an event venue (hereinafter may also be referred to as a “ride sharing vehicle”). Each user operates a predetermined application in the user terminal 200 and can thereby register information on each user needed to use the matching service (hereinafter referred to as “user information”) in the matching management server 300.

The matching management server 300 is a server that manages registered user information. The matching management server 300 executes matching processing for providing the matching service based on the registered user information. Here, the matching processing is processing of matching a plurality of users having the same event venue where a specific event is held as a destination with the same vehicle, that is, processing of combining the plurality of users with one vehicle. Furthermore, the matching management server 300 transmits a matching result of the matching processing to each user terminal 200.

The vehicle 10 is a ride sharing vehicle shared among a plurality of users matched through the matching processing in the matching management server 300. The vehicle 10 travels toward the event venue P which is a common destination of the plurality of users sharing the vehicle. The vehicle-mounted apparatus 100 is mounted on the vehicle 10. The vehicle-mounted apparatus 100 can acquire conversation information relating to conversations generated in the vehicle 10. Note that there are a plurality of ride sharing vehicles and the vehicle-mounted apparatus 100 is mounted on each ride sharing vehicle.

The event management server 400 is a server that manages information on a specific event in which the plurality of users sharing the vehicle 10 participate (that is, an event held at the event venue P). More specifically, the event management server 400 collects information to be provided to a sponsor of the event and transmits information to the participants (users) of the event.

### Hardware Configuration of Server

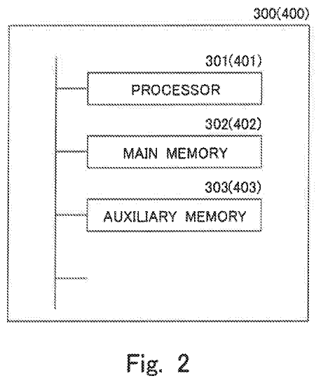

Here, hardware configurations of the matching management server 300 and the event management server 400 will be described based on FIG. 2. FIG. 2 is a diagram illustrating part of hardware configurations of the matching management server 300 and the event management server 400. The matching management server 300 and the event management server 400 are each constructed of a general computer.

The matching management server 300 is provided with a processor 301 such as CPU or DSP, a main memory 302 such as read-only memory (ROM) and random access memory (RAM) and an auxiliary memory 303 such as EPROM, hard disk drive (HDD) or removable medium. Here, the removable medium is a flash memory such as USB memory or SD card or a disk recording medium such as CD-ROM, DVD disk or Blu-ray disk. As with the matching management server 300, the event management server 400 is also provided with a processor 401, a main memory 402 and an auxiliary memory 403.

An operating system (OS), various programs, various information tables or the like are stored in the auxiliary memories 303 and 403 of the respective servers 300 and 400. The processor 301 or 401 of each server 300 or 400 loads a program stored in the auxiliary memory 303 or 403 into the main memory 302 or 402 and executes the program, and can thereby implement various functional modules, which will be described later. However, some or all of the functional modules in each server 300 or 400 may also be implemented by a hardware circuit such as an ASIC or FPGA.

Note that the matching management server 300 and the event management server 400 need not always be implemented in a single physical configuration, but may be constructed of a plurality of computers cooperating with one another. The matching management server 300 and the event management server 400 need not always be physically constructed of a plurality of components but may be constructed of a single computer.

### System Configuration

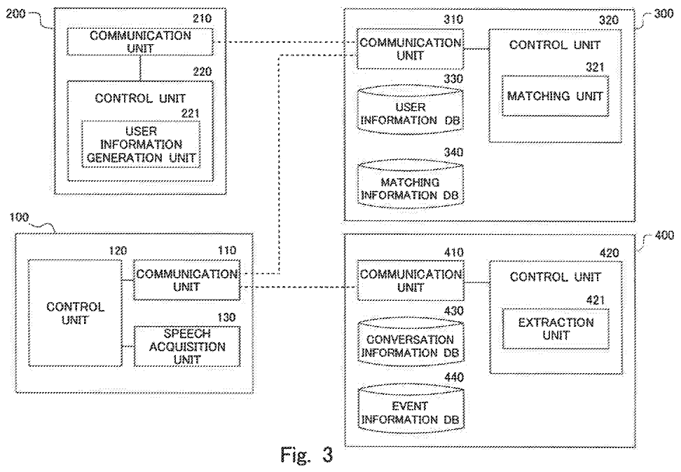

Next, functional configurations of the user terminal 200, the vehicle-mounted apparatus 100, the matching management server 300 and the event management server 400 constituting the information processing system 1 according to the present embodiment will be described based on FIG. 3. FIG. 3 is a block diagram schematically illustrating respective configuration examples of the user terminal 200, the vehicle-mounted apparatus 100, the matching management server 300 and the event management server 400 constituting the information processing system 1 according to the first embodiment.

### User Terminal

The user terminal 200 is constructed of a computer including a processor, a main memory and an auxiliary memory. Examples of the user terminal 200 include a smartphone, a tablet computer, a mobile computer, a wearable computer, a wireless storage, a mobile phone and a handy terminal. The user terminal 200 may also be a personal computer connected to the matching management server 300 via the network N1.

The user terminal 200 includes a communication unit 210 and a control unit 220. The communication unit 210 is communication means for connecting the user terminal 200 to the network N1. The communication unit 210 can communicate with other apparatuses including the matching management server 300 via the network N1 using a mobile communication service such as 3G (3rd Generation) or LTE (Long Term Evolution).

The control unit 220 has a function of performing operation processing for controlling the user terminal 200. The control unit 220 can be implemented by a processor. The processor loads a program stored in the auxiliary memory into the main memory, executes the program, and can thereby implement various functional modules of the control unit 220.

The control unit 220 includes a user information generation unit 221 as a functional module. The user information generation unit 221 generates user information based on an input operation performed by the user on an input/output unit of the user terminal 200 after operating the above-described predetermined application. Here, the user information includes an event ID to identify an event in which the user participates, a venue ID to identify an event venue of the event, and information on a date and time of the event. Furthermore, the user information also includes information on a riding position at which the user gets in the ride sharing vehicle in which the user shares the vehicle with other users when heading for the event venue. For example, when the user decides on the ride sharing vehicle as means for traveling to the event venue of the event in which the user participates, the user inputs a position (desired riding position) at which the user wants to get in the vehicle to the input/output unit of the user terminal 200. In this case, information on the riding position in the user information is generated based on the riding position inputted by the user. For example, when the user inputs the user's own home as the desired riding position to the input/output unit of the user terminal 200, the address of the user's own home may be assumed to be “information on the riding position.” Furthermore, for example, when the user inputs a station nearest to the event venue to the input/output unit of the user terminal 200 as the desired riding position, the name of the nearest station may be assumed to be “information on the riding position.”

The control unit 220 performs processing of transmitting the user information generated in the user information generation unit 221 to the matching management server 300 via the communication unit 210. Furthermore, the control unit 220 performs processing of receiving the matching information which is information on a matching result transmitted from the matching management server 300 via the communication unit 210. Furthermore, the control unit 220 performs processing of outputting the matching information received from the matching management server 300 to an input/output unit (e.g., touch panel display) provided for the user terminal 200.

### Matching Management Server

The matching management server 300 receives user information from each user terminal 200 via the network N1. The matching management server 300 performs matching processing as will be described later based on the received user information on each user. Furthermore, the matching management server 300 transmits matching information which is information relating to a matching result of matching processing to each user terminal 200 and the vehicle-mounted apparatus 100 of the vehicle 10.

The matching management server 300 includes a communication unit 310, a control unit 320, a user information database (user information DB) 330 and a matching information database (matching information DB) 340. The communication unit 310 is communication means for connecting the matching management server 300 to the network N1. The communication unit 310 is constructed of a LAN (Local Area Network) interface board and a wireless communication circuit for wireless communication.

The user information DB 330 is a database for storing user information on each user. More specifically, the user information DB 330 stores user information received from each user terminal 200 in association with each user. The matching information DB 340 is a database that stores matching information. More specifically, the matching information DB 340 stores information on a plurality of users sharing the same ride sharing vehicle matched through the matching processing in association with the ride sharing vehicle.

The user information DB 330 and the matching information DB 340 are constructed in the auxiliary memory 303 by the processor 301 of the matching management server 300 executing a program of a database management system. The user information DB 330 and the matching information DB 340 are, for example, relational databases.

The control unit 320 has a function of performing operation processing for controlling the matching management server 300. The control unit 320 can be implemented by the processor 301. The control unit 320 performs processing of receiving user information transmitted from each user terminal 200 via the communication unit 310 and performs processing of transmitting matching information to each user terminal 200 via the communication unit 310. Furthermore, the control unit 320 performs information management processing such as registration of user information in the user information DB 330 and registration of matching information in the matching information DB 340. The control unit 320 includes a matching unit 321 which is a functional module that executes matching processing.

### Matching Processing

Here, details of matching processing executed by the matching unit 321 will be described. As described above, the matching processing is processing of matching a plurality of users having the event venue where a specific event is held as the destination with the same ride sharing vehicle. The matching unit 321 executes the matching processing based on user information on each user stored in the user information DB 330.

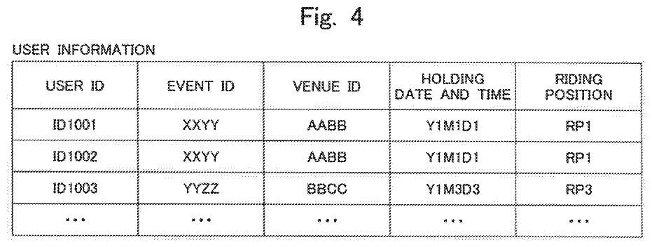

FIG. 4 is a diagram illustrating an example of a table configuration of the user information stored in the user information DB 330. This user information table includes a user ID field, an event ID field, a venue ID field, a holding date and time field and a riding position field.

The user ID field is filled in with a user ID which is identification information for identifying a user. The event ID field is filled in with an event ID included in the user information received from the user terminal 200. The venue ID field is filled in with a venue ID included in the user information received from the user terminal 200. The holding date and time field is filled in with information on an event holding date and time included in the user information received from the user terminal 200. The riding position field is filled in with information on the riding position included in the user information received from the user terminal 200.

Note that matching processing is assumed to be executed here on condition that reception of the user information from each user terminal 200 has been completed and that a sufficient amount of user information is stored in the user information DB 330.

The matching unit 321 acquires user information of each user from the above-described user information DB 330. The matching unit 321 then extracts a plurality of users who participate in the same event (with an identical event ID), held at the same venue (with an identical venue ID) on the same holding date and time as matching candidates based on the acquired user information. The matching unit 321 further extracts and matches users who can get in the same ride sharing vehicle when heading for the event venue from among the plurality of matching candidates based on riding positions of the respective matching candidates.

For example, in the example of the user information table illustrated in FIG. 4, user ID “ID1001” and user ID “ID1002” have the same event ID, venue ID and holding date and time. Therefore, the matching unit 321 extracts the user ID “ID1001” and the user ID “ID1002” as matching candidates in matching processing. Furthermore, the user ID “ID1001” and the user ID “ID1002” have the same riding position (e.g., if the user ID “ID1001” and the user ID “ID1002” want to get in the vehicle at a station nearest to the same event venue, both users have the same riding position). Therefore, it is possible to determine that the users with the user ID “ID1001” and the user ID “ID1002” can get in the same ride sharing vehicle when heading for the event venue. Therefore, the matching unit 321 matches the user ID “ID1001” and the user ID “ID1002” with the same ride sharing vehicle in the matching processing.

Note that in the matching processing, the riding positions of the plurality of users to be matched need not always be identical. For example, on a traveling route when one matching candidate travels in the vehicle from the riding position to the event venue, if a riding position of another matching candidate is located, it is possible to determine that the one matching candidate and the other matching candidate can share the same ride sharing vehicle when heading for the event venue. Therefore, in the matching processing, it is possible to match the one matching candidate traveling in the vehicle from the riding position to the event venue with the other matching candidate located on the traveling route.

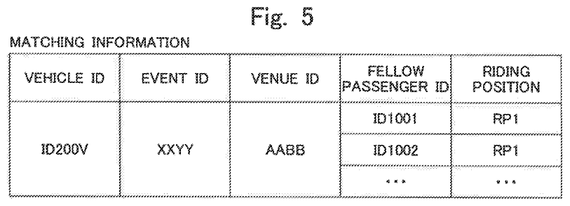

Furthermore, the matching unit 321 registers information on the plurality of users matched through the matching processing in the matching information DB 340. FIG. 5 is a diagram illustrating an example of a table configuration of matching information stored in the matching information DB 340. This matching information table includes a vehicle ID field, an event ID field, a venue ID field, a fellow passenger ID field and a riding position field.

The vehicle ID field is filled in with a vehicle ID which is identification information for identifying a ride sharing vehicle in which the plurality of users matched through the matching processing travel. Here, the ride sharing vehicle in which the plurality of matched users travel may be a vehicle driven by a driver who is one of the plurality of users or a vehicle driven by a driver who is different from the plurality of users. Alternatively, the ride sharing vehicle in which the plurality of matched users travel may also be an autonomous driving vehicle without any driver.

The event ID field is filled in with an event ID of an event in which the plurality of matched users participate. The venue ID field is filled in with a venue ID regarding an event venue which is a common destination of the plurality of matched users. The fellow passenger ID field is filled in with user IDs of the plurality of matched users, respectively. The riding position field is filled in with information on respective riding positions of the plurality of matched users.

As described above, matching information is transmitted to the user terminal 200 of each user matched through matching processing. The matching information includes a vehicle ID of the ride sharing vehicle in which each user heading for the event venue travels. It is thereby possible for each matched user to share the same ride sharing vehicle when heading for the event venue.

### Vehicle-Mounted Apparatus

As described above, the vehicle-mounted apparatus 100 is an apparatus mounted on the vehicle 10 which is the ride sharing vehicle. The vehicle-mounted apparatus 100 is constructed of a computer including a processor, a main memory and an auxiliary memory.

The vehicle-mounted apparatus 100 includes a communication unit 110, a control unit 120 and a speech acquisition unit 130. The communication unit 110 is communication means for connecting the vehicle-mounted apparatus 100 to the network N1. The communication unit 110 can communicate with another apparatus including the matching management server 300 or the event management server 400 via the network N1 using a mobile communication service.

The speech acquisition unit 130 is means for acquiring speech in the vehicle 10. The speech acquisition unit 130 is constructed of a microphone or the like that converts speech in the vehicle 10 to an electric signal. The control unit 120 has a function of performing operation processing of controlling the vehicle-mounted apparatus 100. The control unit 120 can be implemented by a processor. The control unit 120 performs processing of receiving matching information which is information on a matching result transmitted from the matching management server 300 via the communication unit 110. The control unit 120 performs processing of acquiring conversation information relating to conversations generated in the vehicle 10 shared among the plurality of users via the speech acquisition unit 130. The control unit 120 further performs processing of transmitting the conversation information acquired via the speech acquisition unit 130 to the event management server 400 via the communication unit 110.

### Event Management Server

The event management server 400 receives the conversation information from the vehicle-mounted apparatus 100 mounted on each ride sharing vehicle (vehicle 10) via the network N1. The event management server 400 performs extraction processing of extracting event information from the received conversation information in each ride sharing vehicle. Here, the event information is information on a specific event held at the event venue which is the destination of each ride sharing vehicle. Details of the extraction processing will be described later.

The event management server 400 includes a communication unit 410, a control unit 420, a conversation information database (conversation information DB) 430 and an event information database (event information DB) 440. The communication unit 410 is communication means for connecting the event management server 400 to the network N1. The communication unit 410 is constructed of, for example, a LAN (Local Area Network) interface board and a wireless communication circuit for wireless communication.

The conversation information DB 430 is a database that stores conversation information on each ride sharing vehicle. More specifically, the conversation information DB 430 stores conversation information received from the vehicle-mounted apparatus 100 in each ride sharing vehicle in association with each ride sharing vehicle. Furthermore, the event information DB 440 is a database that stores event information. More specifically, the event information DB 440 stores event information extracted from conversation information through extraction processing in association with each event.

The conversation information DB 430 and the event information DB 440 are constructed in an auxiliary memory 403 by a processor 401 of the event management server 400 executing a program of a database management system. The conversation information DB 430 and the event information DB 440 are, for example, relational databases.

The control unit 420 has a function of performing operation processing for controlling the event management server 400. The control unit 420 can be implemented by the processor 401. The control unit 420 executes processing of receiving conversation information transmitted from the vehicle-mounted apparatus 100 of each ride sharing vehicle via the communication unit 410. The control unit 420 executes information management processing such as registration of conversation information in the conversation information DB 430 and registration of event information in the event information DB 440. The control unit 420 includes an extraction unit 421 which is a functional module that executes extraction processing.

Note that in the present embodiment, the event management server 400 corresponds to an “information processing apparatus” according to the first aspect or the fourth aspect of the present disclosure.

### Extraction Processing

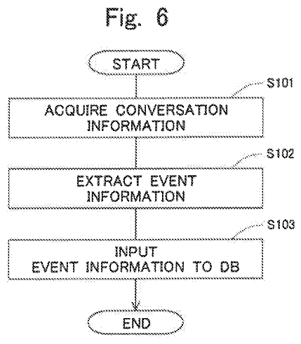

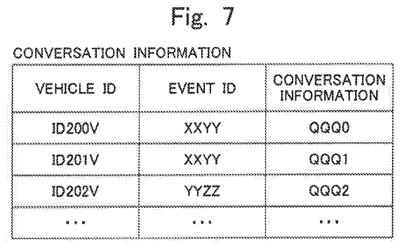

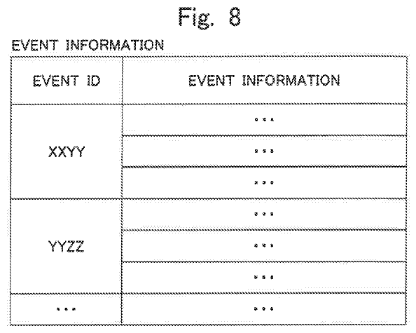

Here, details of the extraction processing executed by the extraction unit 421 will be described. As described above, the extraction processing is processing of extracting event information relating to a specific event held at the event venue which is the destination of each ride sharing vehicle. FIG. 6 is a flowchart illustrating a flow of extraction processing executed by the extraction unit 421. FIG. 7 is a diagram illustrating an example of a table configuration of conversation information stored in the conversation information DB 430. FIG. 8 is a diagram illustrating an example of a table configuration of the conversation information stored in the event information DB 440.

In the flow illustrated in FIG. 6, the conversation information stored in the conversation information DB 430 is acquired first in S101. As illustrated in FIG. 7, the conversation information table stored in the conversation information DB 430 includes a vehicle ID field, an event ID field and a conversation information field.

The vehicle ID field is filled in with a vehicle ID which is identification information for identifying a ride sharing vehicle on which the vehicle-mounted apparatus 100 which is a source of conversation information is mounted. The event ID field is filled in with an event ID regarding a specific event held at an event venue which is a destination of the ride sharing vehicle. The conversation information field is filled in with conversation information received from the vehicle-mounted apparatus 100. Note that the conversation information field may store conversation information as speech data or as text data generated by converting speech data. In S101, by acquiring the conversation information from such a conversation information table, it is possible to acquire the conversation information associated with the event ID.

Here, a plurality of users matched through the aforementioned matching processing who participate in the same event are sharing each ride sharing vehicle. Each ride sharing vehicle is traveling toward the event venue where the event in which the plurality of users participate is held. Thus, in the ride sharing vehicle, conversations concerning a specific event (that is, the event which is held at the event venue which is the destination of the ride sharing vehicle and in which the plurality of users participate) are considered likely to be generated among the plurality of users in the vehicle. Thus, there is a high possibility that the conversation information stored in the conversation information DB may include a large amount of information on the specific event corresponding to the event ID associated with the conversation information.

Next, in S102, event information is extracted from the conversation information acquired in S101. At this time, event information on a specific event corresponding to the event ID associated with each piece of conversation information is extracted from each piece of conversation information. More specifically, for example, a keyword database (keyword DB) storing a plurality of keywords relating to the specific event corresponding to each event ID may be stored in the auxiliary memory 403 of the event management server 400 in advance. The event information may be extracted by extracting sentences including the keywords stored in the keyword DB from the conversation information. At this time, a sponsor name, a performer name, a performance (or movie presentation) work name, a name of exhibited article, a name of sales article or the like of the specific event may be illustrated as the keywords. Note that in the process in S102, the technique of extracting the event information from the conversation information is not limited to such a technique, but any publicly known technique may be adopted.

Next, in S103, the event information extracted in S102 is registered in the event information DB 440. As illustrated in FIG. 8, the event information table stored in the event information DB 440 includes an event ID field and an event information field.

The event ID field is filled in with an event ID of a specific event held at the event venue which is the destination of the ride sharing vehicle. The event information field is filled in with event information on the specific event corresponding to each event ID extracted in 5102.

As described above, according to the present embodiment, it is possible to acquire event information based on a conversation performed among a plurality of users heading for the same event venue in the same ride sharing vehicle. It is thereby possible to collect event information from the conversation among the plurality of users highly interested in a specific event and performed in the same time period as that of the specific event. Therefore, it is possible to collect useful information on the specific event.

For example, when the sponsor of the specific event acquires the event information collected as described above, it is possible to adjust a content of the specific event based on the event information. More specifically, it is possible to change performers, performance (or movie presentation) work, exhibited articles, sales articles or food and drink provided at the event venue or performing order of the performers, performing order of the performance (or movie presentation) work, exhibition place of the exhibited articles, quantities of the sales articles or the food and drink or the like in the specific event.

### Modifications

In the above-described first embodiment, the event management server 400 receives conversation information from the vehicle-mounted apparatus 100. The event management server 400 extracts event information from the received conversation information. However, the event management server 400 need not always execute these processes. For example, the vehicle-mounted apparatus 100 may execute extraction processing of extracting event information from conversation information.

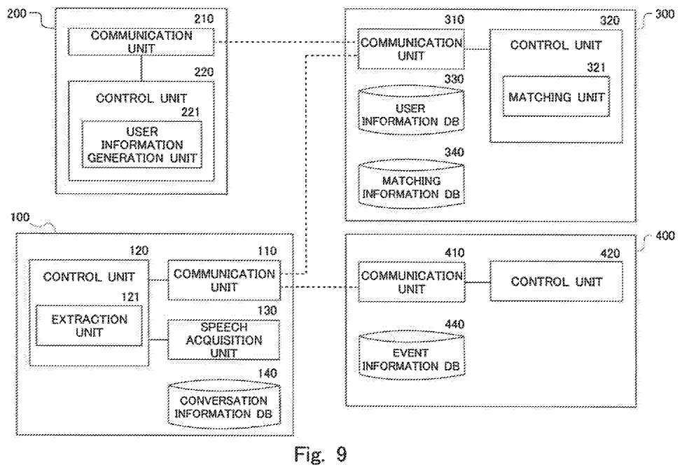

FIG. 9 is a block diagram schematically illustrating respective configuration examples of the user terminal 200, the vehicle-mounted apparatus 100, the matching management server 300 and the event management server 400 constituting the information processing system 1 according to a modification of the first embodiment.

As illustrated in FIG. 9, in the present modification, the event management server 400 is not provided with the conversation information DB 430, and the vehicle-mounted apparatus 100 is provided with a conversation information DB 140 instead. In this case, the conversation information DB 140 is constructed in the auxiliary memory of the vehicle-mounted apparatus 100. A table configuration of conversation information stored in the conversation information DB 140 is similar to the table configuration illustrated in FIG. 7. As illustrated in FIG. 9, in the present modification, the control unit 420 of the event management server 400 is not provided with the extraction unit 421, and the control unit 120 of the vehicle-mounted apparatus 100 is provided with an extraction unit 121 instead. In this case, the extraction unit 121 can be implemented by the processor of the vehicle-mounted apparatus 100 loading the program stored in the auxiliary memory into the main memory and executing the program.

In the present modification, the control unit 120 in the vehicle-mounted apparatus 100 registers conversation information acquired via the speech acquisition unit 130 in the conversation information DB 140. The extraction unit 121 in the control unit 120 executes extraction processing based on the conversation information stored in the conversation information DB. At this time, the extraction unit 121 executes processes similar to those in S101 and S102 in the flowchart illustrated in FIG. 6. As with the above-described first embodiment, event information is extracted from the conversation information.

Furthermore, the control unit 120 transmits the event information extracted through the extraction processing by the extraction unit 121 to the event management server 400 via the communication unit 110. The control unit 420 in the event management server 400 executes processing of receiving the event information transmitted from the vehicle-mounted apparatus 100 via the communication unit 410. Furthermore, the control unit 420 registers the received event information in the event information DB 440. In this case, the table configuration of the event information stored in the event information DB 440 is similar to the table configuration illustrated in FIG. 8.

Thus, as with the above-described first embodiment, it is possible to acquire event information based on conversations performed among a plurality of users heading for the same event venue in the same ride sharing vehicle in the present modification as well.

Note that in the present modification, the vehicle-mounted apparatus 100 corresponds to the “information processing apparatus” according to the first aspect or the fourth aspect of the present disclosure.

### SECOND EMBODIMENT

In the present embodiment, content information on a predetermined content in a specific event held at an event venue which is a destination of a plurality of users sharing the same ride sharing vehicle is provided to the plurality of users. Here, the predetermined content is a target content for which a sponsor of the specific event wants to collect information on the specific event from the users.

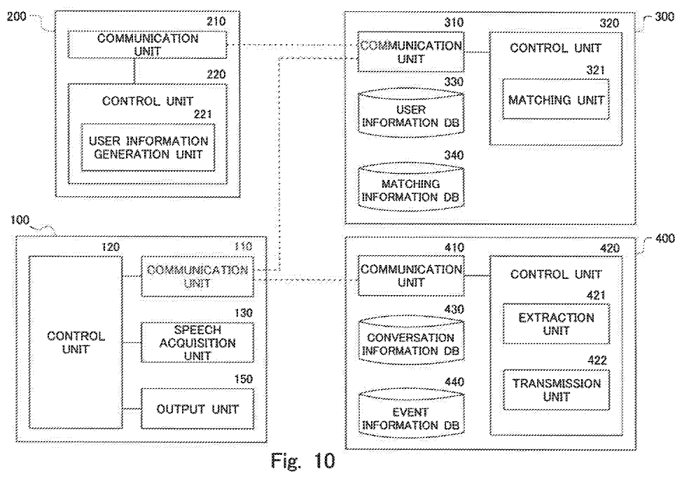

FIG. 10 is a block diagram schematically illustrating respective configuration examples of the user terminal 200, the vehicle-mounted apparatus 100, the matching management server 300 and the event management server 400 constituting the information processing system 1 according to a modification of the present embodiment. In the present embodiment, the control unit 420 of the event management server 400 includes a transmission unit 422 in addition to the extraction unit 421 as a functional module.

The transmission unit 422 executes transmission processing of transmitting content information on a predetermined content to the vehicle-mounted apparatus 100 via the communication unit 410. The content information is inputted to the event management server 400 by the sponsor of the specific event. The content information may be image information, character information or speech information, or a combination thereof.

For example, when the sponsor of the specific event wants to collect information on performers of the event from the users, information on the performers is inputted to the event management server 400 as content information. On the other hand, when the sponsor of the specific event wants to collect information on the performance (or movie presentation) work in the event from the users, information on the performance (or movie presentation) work is inputted to the event management server 400 as content information. Furthermore, when the sponsor of the specific event wants to collect information on food and drink provided in the event venue from the users, information on the food and drink is inputted to the event management server 400 as content information.

The transmission unit 422 transmits the content information inputted to the event management server 400 to the vehicle-mounted apparatus 100 of the ride sharing vehicle. The ride sharing vehicle which is the destination of the content information at this time is a vehicle heading for the event venue of the specific event where a content corresponding to the content information transmitted is provided to the users as the destination. The control unit 120 in the vehicle-mounted apparatus 100 executes processing of receiving the content information transmitted from the event management server 400 via the communication unit 110.

In the present embodiment, the vehicle-mounted apparatus 100 is provided with an output unit 150 that outputs the received content information to the inside of the vehicle 10. The output unit 150 is constructed of a monitor and a speaker or the like. The content information is outputted from the output unit 150, and the content information is thereby provided to a plurality of users in the vehicle 10.

### System Operation

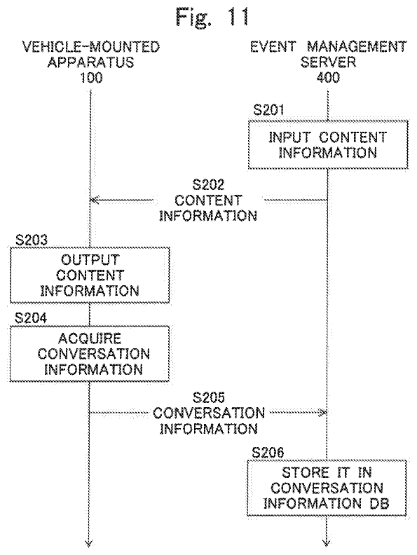

Processing executed by the event management server 400 and the vehicle-mounted apparatus 100 and a flow of transmission/reception of information between both apparatuses according to the present embodiment will be described based on FIG. 11.

The event management server 400 receives content information relating to a predetermined content from the sponsor of the specific event (S201). The received content information is transmitted from the event management server 400 to the vehicle-mounted apparatus 100 (S202). The received content information in the vehicle-mounted apparatus 100 is then outputted (S203). Thus, the content information is provided to the plurality of users in the vehicle 10 mounted with the vehicle-mounted apparatus 100. In this way, when the content information related to the specific event is provided to the plurality of users who participate in the specific event, the plurality of users are urged to perform conversations relating to the predetermined content corresponding to the content information.

The vehicle-mounted apparatus 100 acquires conversation information under a situation in which the plurality of users are urged to perform conversations concerning the predetermined content (S204). Furthermore, the acquired conversation information is transmitted from the vehicle-mounted apparatus 100 to the event management server 400 (S205). The received conversation information in the event management server 400 is stored in the conversation information DB 430 (S206). After that, the event management server 400 executes extraction processing based on the conversation information stored in the conversation information DB 430 as with the first embodiment.

As described above, in the present embodiment, conversation information is acquired under a situation in which a plurality of users sharing the same ride sharing vehicle are urged to perform conversations concerning a predetermined content in a specific event in which the plurality of users participate. Therefore, the acquired conversation information is more likely to include information on the predetermined content transmitted from the users. As a result, the event information extracted from the conversation information through the extraction processing is more likely to include information on the predetermined content transmitted from the users. Therefore, it is possible to collect more information that the sponsor of a specific event wants to collect from the users from the conversation information.

### Modifications

In the above-described second embodiment, contents of the extraction processing executed based on conversation information stored in the conversation information DB 430 are assumed to be similar to those of the first embodiment. However, in the second embodiment, extraction processing may be executed by taking into account the content information transmitted from the event management server 400 to the vehicle-mounted apparatus 100. That is, in the extraction processing, information related to the content information may be extracted from the conversation information as event information. More specifically, the event information may be extracted, for example, by extracting sentences in which keywords related to a predetermined content corresponding to the content information from the conversation information.

It is thereby possible to extract information on the predetermined content transmitted from the users from the conversation information with a higher probability. Therefore, it is possible to collect information that the sponsor of a specific event wants to collect from the users more intensively.

Note that in the present embodiment, the event management server 400 corresponds to the “information processing apparatus” according to the first aspect or the fourth aspect of the present disclosure.

The technique relating to provision of content information to a plurality of users sharing the same ride sharing vehicle according to the second embodiment is also applicable to the modification of the first embodiment. That is, even when the vehicle-mounted apparatus 100 executes extraction processing of extracting event information from the conversation information, the event management server 400 may transmit the content information to the vehicle-mounted apparatus 100 and the vehicle-mounted apparatus 100 may output the content information to the inside of the vehicle 10, and can thereby obtain effects similar to the aforementioned effects.

### Other Embodiments

The above embodiments are merely examples and the present disclosure can be implemented, modified as appropriate without departing from the spirit and scope of the present disclosure. Furthermore, the processing and means described in the present disclosure can also be executed by freely combining the processing and means unless technical inconsistencies are generated.

Furthermore, processing described as to be executed by one apparatus may be executed by being divided among a plurality of apparatuses. Alternatively, processing described as to be executed by different apparatuses may be executed by one apparatus. In a computer system, a hardware configuration (server configuration) that executes each function can be flexibly changed.

The present disclosure can also be implemented by providing to a computer, a computer program mounted with the functions described in the above-described embodiments and by one or more processors of the computer reading and executing the program. Such a computer program may be provided to the computer with a non-transitory computer-readable storage medium connectable to a system bus of the computer or may be provided to the computer via a network. Examples of the non-transitory computer-readable storage medium include a magnetic disk (floppy (registered trademark) disk, a hard disk drive (HDD),or the like), an arbitrary type disk such as an optical disk (CD-ROM, DVD disk, Blu-ray disk or the like) or the like, a read-only memory (ROM), a random access memory (RAM), an EPROM, an EEPROM, a magnetic card, a flash memory, an optical card, an arbitrary type medium suitable for storing electronic instructions.

What is claimed is:

1. An information processing apparatus comprising a controller configured to execute:
acquiring conversation information on a conversation generated in a vehicle shared among a plurality of users having a same event venue where a specific event is held as a destination; and
extracting event information on the specific event from the conversation information.

2. The information processing apparatus according to claim 1, wherein the controller further executes providing content information relating to a predetermined content in the specific event to the plurality of users in the vehicle.

3. The information processing apparatus according to claim 2, wherein the controller extracts information associated with the content information from the conversation information as the event information.

4. An information processing method comprising:
a step of acquiring conversation information on a conversation generated in a vehicle shared among a plurality of users having a same event venue where a specific event is held as a destination; and
a step of extracting event information on the specific event from the conversation information.

5. A non-transitory storage medium that stores a program for causing a computer to execute the information processing method according to claim 4.

6. An information processing system comprising:
a matching apparatus configured to match a plurality of users with a same vehicle based on destination information of each user, the plurality of users having a same event venue where a specific event is held as a destination; and
an information processing apparatus configured to acquire conversation information on a conversation generated in the vehicle shared among the plurality of users and extract event information on the specific event from the conversation information.
